(19) United States
(12) Patent Application Publication
(10) Pub. No.: US 2007/0013937 A1
(43) Pub. Date: Jan. 18, 2007

(54) Image forming device and user terminal device for providing guide information and method of providing guide information thereof

(75) Inventors: Ji-hyun Kim, Suwon-si (KR); Sook-hyun Kong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/485,355

(22) Filed: Jul. 13, 2006

(30) Foreign Application Priority Data
Jul. 12, 2005 (KR) 2005-68232

(51) Int. Cl. G06F 3/12

(52) U.S. Cl. 358/1.13

(57) ABSTRACT

An image forming device and a user terminal device for providing guide information and a method of providing guide information thereof are provided, where metadata of image data to print is analyzed, guide information for a certain printing option based on the analyzed metadata is generated, and the guide information to the image data is applied and the image data is printed. Accordingly, a printing option can be obtained to print the image data from the image forming device and the user terminal device.

### CROSS-REFERENCE TO RELATED APPLICATIONS

This application claims the benefit under 35 U.S.C. § 119(a) of Korean Patent Application No. 2005-68232, filed Jul. 27, 2005 in the Korean Intellectual Property Office, the entire disclosure of which is hereby incorporated by reference.

### BACKGROUND OF THE INVENTION

1. Field of the Invention

The present invention relates to an image forming device and a user terminal device for providing guide information, and a method of providing guide information thereof. More particularly, the present invention relates to an image forming device and a user terminal device for providing guide information for a printing option in order to set the printing option suitable for data and a method of providing guide information thereof.

2. Description of the Related Art

As digital technologies develop, image pickup devices such as a digital camera and digital camcorder are becoming popular. Further image forming apparatuses such as printers have improved the image quality of images printed in such an extent that image-dedicated printers have been introduced and are also becoming popular.

Users increasingly prefer to personally output images photographed by using the image forming apparatus such as the image-dedicated printer and therefore without traveling to a digital photo developer.

The process of personally outputting the image using the image forming apparatus is as follows. The user retrieves an image to print from storage or a host and selects a printing option to apply to the image. The image forming apparatus outputs the image according to the printing option selected by the user.

When personally outputting an image using the image forming apparatus as described above, the user must select a printing option to apply to the image. Accordingly, the user must be knowledgeable of the functions provided by the image forming apparatus and information on the printing option required to output the image.

If the user is not knowledgeable of the printing option required to output the image or does not appropriately set the printing option to the image in order to print, a high quality image cannot be obtained.

Accordingly, there is a need for an improved image forming device and method for providing printing option information in order to output a high quality image.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an image forming device and a user terminal device for providing guide information for the printing option suitable for image data to a user based on metadata of the image data and a method of providing guide information thereof.

In order to achieve the above-described aspects of exemplary embodiments the present invention, there is provided an image forming apparatus for providing guide information, where a controller analyzes metadata of image data to print and generates guide information for a certain printing option based on the analyzed metadata, a user interface provides the generated guide information to a user and receives a setting value for the printing option from the user, and a printing unit prints the image data, wherein the controller controls the printing unit to apply the input setting value for the printing option to the image data and print the image data.

In an exemplary implementation, the controller may further comprise a guide information generator that analyzes the metadata of the image data and generates the guide information for the certain printing option based on the analyzed metadata.

In a further exemplary implementation, the printing option may correspond to a printing setting comprising a color mode, sharpness and brightness.

In another exemplary implementation, the image forming apparatus may further comprise an image data input unit that reads the image data from an external storage medium, wherein the controller can receive the image data from the image data input unit. The external storage medium may be at least one of a user terminal device, digital camera and digital camcorder.

Further, in an exemplary implementation, the user interface may comprise a function key that inputs the setting value for the printing option and a display unit that displays the guide information.

In an exemplary implementation, the controller may control the printing unit to print a demonstration page of the guide information.

According to an aspect of exemplary embodiments of the present invention, there is provided a user terminal device for providing guide information, where a guide information generator analyzes metadata of image data to print and generates guide information for a certain printing option based on the analyzed metadata, a driver comprising a driver user interface provides the generated guide information to a user and receives a setting value for the printing option from the user, and a driver controller generates a printing control signal to apply the setting value for the printing option to the image data and print the image data, and an image forming apparatus interface transmits the generated printing control signal to an image forming apparatus.

In an exemplary implementation, the printing option may correspond to a printing setting comprising a color mode, sharpness and brightness.

In another exemplary implementation, the user terminal device may further comprise a terminal device storage that stores the image data, wherein the guide information generator may receive the image data from the terminal device storage.

In a further exemplary implementation, the driver controller may generate a printing control signal to print a demonstration page of the guide information.

According to another aspect of exemplary embodiments of the present invention, there is provided a method of providing guide information, where metadata of image data to print is analyzed, guide information for a certain printing option based on the analyzed metadata is generated, the guide information is applied to the image data and the image data is printed.

In a further exemplary implementation, the printing option may correspond to a printing setting comprising a color mode, sharpness and brightness.

In an exemplary implementation the guide information is provided to a user through a display device or a host device.

In another exemplary implementation the providing of the guide information provides a demonstration page of the guide information to the user by printing or displaying.

In a further exemplary implementation, a setting value for the printing option is received from the user, if the user wants to print the image data in a setting value different from the guide information.

In an exemplary implementation, the analyzed metadata, the generated guide information and the setting value for the printing option by the user are stored in the metadata.

In another exemplary implementation, the record of the setting value is managed for the printing option stored in the metadata. The setting value for the printing option stored in the metadata is printed.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWING FIGURES

The above aspect and other objects, features, and advantages of certain exemplary embodiments of the present invention will be more apparent from the following description taken in conjunction with the accompanying drawings, in which:

FIG. 1 is a block diagram of an image forming apparatus for providing guide information according to an exemplary embodiment of the present invention;

FIG. 2 is a block diagram of a user terminal device for providing guide information according to an exemplary embodiment of the present invention;

FIG. 3A and FIG. 3B are views describing a method of providing guide information;

FIG. 4 is a view showing an image effect according to a method of providing guide information according to an exemplary embodiment of the present invention; and

FIG. 5 is a flow chart describing a method of providing guide information according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

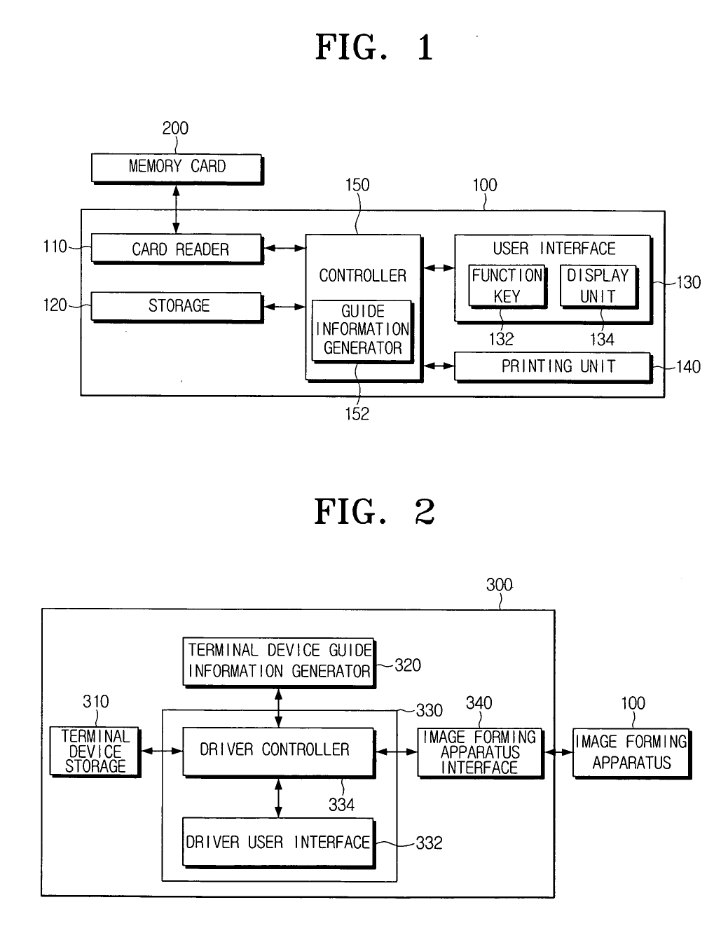

FIG. 1 is a block diagram of an image forming apparatus for providing guide information according to an exemplary embodiment of the present invention.

Referring to FIG. 1, the image forming apparatus 100 comprises an image data input unit, storage 120, user interface 130, printing unit 140, and controller 150.

The image data input unit reads image data from an external storage medium. The external storage medium may be at least one of a user terminal device, digital camera and digital camcorder. In an exemplary implementation, a card reader 110 includes the image data input unit, as shown in FIG. 1.

The card reader 110 reads at least one image data stored in the external storage medium, for example, a memory card 200, and provides the image data to the controller 150.

The storage 120 stores at least one image data and provides the stored image data by control of the controller 150. The storage 120 can store image data read by the card reader 110 or image data transmitted from the user terminal device.

In an exemplary implementation, the image data applied may be data including an exchangeable image file format (EXIF) header which can store certain data by a user's selection.

Files, such as, a joint photographic experts group (JPEG) format and tag image file format (TIFF) are examples of image data that includes the EXIF header. In an exemplary implementation, the image photographed by the digital camera or the digital camcorder is stored in the JPEG format including the EXIF header.

The user interface 130 provides guide information generated by a guide information generator 152 to a user and receives a setting value for the printing option to apply to the image data from the user. The user interface 130 comprises a function key 132 and a display unit 134.

The function key 132 is formed on a general front panel and inputs a signal requested by a user's manipulation. In an exemplary embodiment of the present invention, the user may input the setting value for the printing option to apply to the image data by manipulating the function key 132.

The display unit 134 is also formed on the front panel and displays certain information. In an exemplary embodiment of the present invention, the display unit 134 displays the guide information generated by the guide information generator 152 so that the user may confirm the guide information provided from the image forming apparatus 100. Accordingly, the display unit 134 may be implemented in a touch screen that functions as the function key 132 so that the function key 132 can be omitted.

The printing unit 140 prints certain data, that is, image data by applying the setting value for the printing option input through the user interface 130 by control of the controller 150 to the image data.

The controller 150 controls overall functions of the image forming apparatus 100. That is, the controller 150 controls input and output signals received from the card reader 110, storage 120, guide information generator 152, user interface 130 and printing unit 140.

The controller 150 comprises the guide information generator 152 for analyzing metadata of image data and generating guide information for the certain printing option based on the analyzed metadata.

The guide information generator 152 analyzes metadata of image data to print. That is, the guide information generator 152 analyzes an EXIF header and generates guide information for the printing option based on the analyzed metadata. The printing option includes a color mode, sharpness and brightness.

When a user wants to output image data stored in the memory card 200, the guide information generator 152 receives the image data from the card reader 110. On the other hand, when a user wants to output image data stored in the storage 120, the guide information generator 152 receives the image data from the storage 120.

Table 1 shows an EXIF header analyzed by the guide information generator 152.

TABLE 1

| Exif data Name | Value | |
|---|---|---|
| ExposureTime | 0.5 | sec |
| FNumber | F2.8 | |
| CompressedBitsPerPixel | 3 | |
| ShutterSpeedValue | 1/80 | sec |
| ApertureValue | 5 | |
| BrightnessValue | 2.0 | EV |
| ExposureBiasValue | 5.0 | EV |
| LightSource | 10 | |
| FocalLength | 15.6 | mm |
| ExifImage Width | 960 | |
| ExifImageHeight | 1280 | |
| FocalPlaneXResolution | 2448 | |
| FocalPlaneYResolution | 3264 | |

. . .

The EXIF header of the image data stores information and Table 1 exemplifies part of the information. The guide information generator 152 analyzes the EXIF header according to Table 1 and extracts the optimum value of the information according to Table 2 to print the image data in an improved state.

TABLE 2

| Exif data Name | Value | |
|---|---|---|
| ExposureTime | 0.5 | sec |
| FNumber | F2.8 | |
| CompressedBitsPerPixel | 3 | |
| ShutterSpeedValue | 1/80 | sec |
| ApertureValue | 5 | |
| BrightnessValue | 1.50 | EV |
| ExposureBiasValue | 5.0 | EV |
| LightSource | 10 | |
| FocalLength | 15.6 | mm |
| ExifImageWidth | 960 | |
| ExifImageHeight | 1280 | |
| FocalPlaneXResolution | 2000 | |
| FocalPlaneYResolution | 3000 | |

. . .

Comparing Table 1 and Table 2, the guide information generator 152 changes ‘2.0EV’ into ‘1.5EV’ in ‘BrightnessValue’, ‘2448’ into ‘2000’ in ‘FocalPlaneXResolution’, and ‘3264’ into ‘3000’ in ‘FocalPlaneYResolution’. The guide information generator 152 changes values to print the image data in the improved state and generates the corresponding guide information.

The controller 150 controls the guide information generated by the guide information generator 152 to be displayed on the display unit 134. The controller 150 also controls a terminal device interface (not shown) to transmit the guide information to the user terminal device and display the guide information on a display device connected to the user terminal device. Additionally, the controller 150 can control the printing unit 140 to print a demonstration page of the guide information.

The controller 150 controls the printing unit 140 to apply a setting value for the printing option input by the user through the user interface 130 to the image data, and print the image data. The user inputs the setting value for the printing option with reference to the guide information.

The controller 150 comprises a metadata analyzed by the guide information generator 152, the guide information generated by the guide information generator 152 and the setting value for the printing option input by the user through the display unit 134 or the printing unit 140 for selection. Subsequently, a selection is received, the controller 150 controls the printing unit 140 to print image data according to the selection.

Additionally, the controller 150 may store the metadata analyzed by the guide information generator 152, the guide information generated by the guide information generator 152 and the setting value for the printing option input by the user in the metadata. Accordingly, a history of the setting value for the printing option stored in the metadata may be managed.

Further, the controller 150 may control the printing unit 140 to print the setting value for the printing option stored in the metadata, if necessary.

FIG. 2 is a block diagram of a user terminal device to provide guide information, according to an exemplary embodiment of the present invention.

Referring to FIG. 2, the user terminal device 300 to provide guide information according to an exemplary embodiment of the present invention comprises a terminal device storage 310, driver 330 and image forming apparatus interface 340.

The terminal device storage 310 stores at least one image data. The image data can be an image which is photographed by an image pickup device, such as, a digital camera, and is downloaded to the user terminal device 300.

The driver 330 is a general driver program to control driving of the image forming apparatus 100. The driver 330 comprises a terminal device guide information generator 320, driver user interface 332, and driver controller 334.

The terminal device guide information generator 320 analyzes metadata of image data to print, and generates guide information of a certain printing option based on the metadata. The terminal device guide information generator 320 performs similar functions as the guide information generator 152 of FIG. 1.

The driver user interface 332 supports the interface between the user terminal device 300 and the image forming apparatus 100. That is, the driver user interface 332 provides the guide information generated by the terminal device guide information generator 320 to a user and receives a setting value for the printing option from the user.

In an exemplary implementation, the driver 330 provides a menu to set a driving condition of the image forming apparatus 100 such as paper setting, printing quality, number of printing, color mode, sharpness and brightness through a user interface 332.

The driver user interface 332 can be displayed on a display device (not shown) connected to the user terminal device 300. Accordingly, the driver user interface 332 displays the guide information generated by the terminal device guide information generator 320 on the display device to provide to a user. The user sets the setting value for the printing option with reference to the guide information displayed through the user interface 332.

The driver controller 334 controls the overall functions of the driver 330 to control driving of the image forming apparatus 100. Accordingly, the driver controller 334 controls input and output signals between the terminal device guide information generator 320 and the driver user interface 332.

The driver controller 334 generates a printing control signal to print image data to apply the setting value for the printing option input through the driver user interface 332 and print the image data. Additionally, the driver controller 334 controls the image forming apparatus interface 340 to transmit the generated printing control signal to the image forming apparatus 100.

The image forming apparatus interface 340 supports the interface between the user terminal device 300 and the image forming apparatus 100. The image forming apparatus interface 340 transmits the printing control signal generated by control of the driver controller 334 to the image forming apparatus 100.

As shown in FIG. 2, the user terminal device 300 and the image forming apparatus 100 are connected to each other in a wired or wireless way to mutually transmit and receive data. The signal transmitted and received between the user terminal device 300 and the image forming apparatus 100 includes image data to print and the printing control signal.

As shown in FIG. 2, the image forming apparatus 100 has the same reference numeral as the image forming apparatus 100 of FIG. 1, but the user terminal device 300 of FIG. 2 performs the functions of the image forming apparatus 100 of FIG. 1. Therefore, the image forming apparatus 100 of FIG. 2 does not necessarily have the functions of the image forming apparatus 100 described in FIG. 1. In other words, the image forming apparatus 100 of FIG. 2 may comprise a printing unit 140 to perform printing and a terminal device interface (not shown) to support the interface to the user terminal device 300.

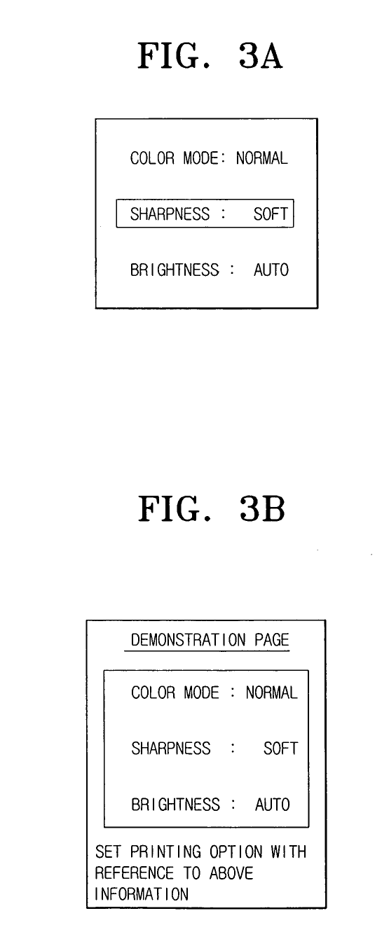

FIG. 3A and FIG. 3B are views describing a method of providing guide information.

If a user selects image data to print, the guide information generator 152 and the terminal device guide information generator 320 analyze metadata of the image data, determine an optimum printing option which is suitable for the feature of the image data based on the analyzed metadata, and generate the corresponding guide information.

In an exemplary implementation, the guide information comprises normal for color mode, soft for sharpness, and auto for brightness.

FIG. 3A corresponds to a state that guide information for the printing option is displayed.

In the image forming apparatus 100 of FIG. 1, the controller 150 controls guide information generated by the guide information generator 152 to be displayed on the display unit 134. The display unit 134 displays guide information such as FIG. 3A by control of the controller 150.

In the user terminal device 300 of FIG. 2, the driver controller 334 controls guide information generated by the terminal device guide information generator 320 to be displayed through the driver user interface 332. Accordingly, guide information such as FIG. 3B is displayed on the display device (not shown) by the driver user interface 332.

FIG. 3B corresponds to the state that guide information for the printing option is printed.

In the image forming apparatus 100 of FIG. 1, if the guide information generator 152 generates guide information, the controller 150 controls the printing unit 140 to print the guide information. The printing unit 140 prints the guide information such as FIG. 3B in a preset template by control of the controller 150.

In the user terminal device 300 of FIG. 2, if the terminal device guide information generator 320 generates guide information, the driver controller 334 generates a printing control signal to print the guide information. The printing control signal is transmitted to the image forming apparatus 100 through the image forming apparatus interface 340. Subsequently, the printing unit 140 of the image forming apparatus 100 prints the guide information such as FIG. 3B. For example, the message, such as, ‘Set printing option with reference to above information’ may be printed on one side of page printed with the guide information.

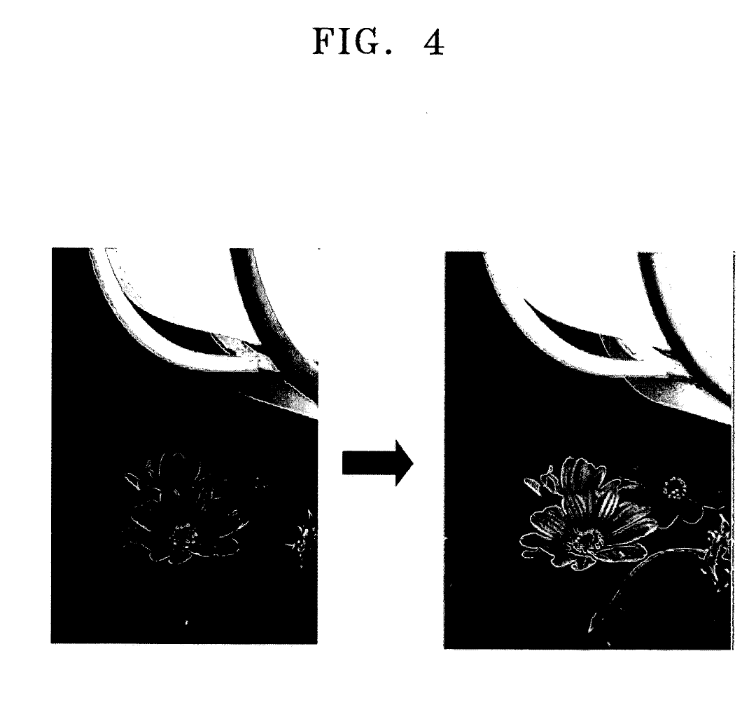

FIG. 4 is a view showing an effect by a method of providing guide information according to an exemplary embodiment of the present invention.

If the guide information generated by the guide information generator 152 of the image forming apparatus 100 or the terminal device guide information generator 320 of the user terminal device 300 is provided as shown in FIG. 3A and FIG. 3B, a user may set the printing option to apply to the image data with reference to the guide information. The user sets the printing option through the function key 132 or driver user interface 332.

If the user inputs the printing option, the controller 150 of the image forming apparatus 100 controls the printing unit 140 to print the image data with the input printing option applied. The driver controller 334 of the user terminal device 300 then generates a printing control signal to print the image data according to the printing option. Accordingly, with the printing option applied, the image data are printed so that output with improved image quality can be obtained as shown in FIG. 4.

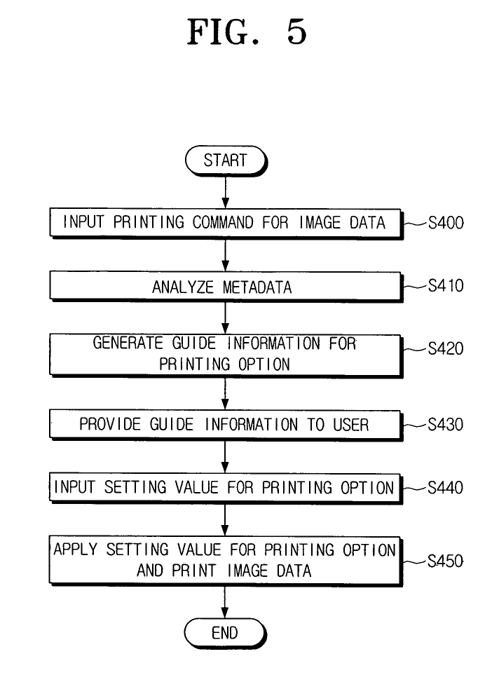

FIG. 5 is a flow chart describing a method of providing guide information according to an exemplary embodiment of the present invention.

A method of providing guide information of the image forming apparatus 100 in FIG. 1 is described.

A printing command for image data read from the memory card 200 by the card reader 110 or image data stored in the storage 120 is input. The image data is data of JPEG or TIFF format including an EXIF header (S400).

The guide information generator 152 analyzes metadata, that is, the EXIF header of the image data corresponding to the printing command (S410) and generates guide information for the printing option according to the analyzed EXIF header (S420).

After the guide information generator 152 generates the guide information, the controller 150 controls the user interface 130 to provide the guide information to a user. The guide information can be displayed on the display unit 134 of the user interface 130 and can be printed in the printing unit 140 (S430).

The user inputs a setting value for the printing option to apply to the image data with reference to the guide information displayed on the display unit 134 by manipulating the function key 132 or the display unit 134 (S440).

After the setting value for the printing option is input from the user interface 130, that is, the function key 132 or the display unit 134, the controller 150 controls the printing unit 140 to apply the setting value and print the image data. Accordingly, the printing unit 140 prints the image data according to the printing option set by the user (S450).

In the user terminal device 300, as printing is not supported, the driver controller 334 generates a printing control signal to print the image data according to the printing option set by the user, and transmits the generated printing control signal to the image forming apparatus 100 to perform printing in the S450.

Therefore, the user can receive information regarding the printing option to apply to the image data through the guide information provided from the guide information generator 152 of the image forming apparatus 100 and the terminal device guide information generator 320 of the user terminal device 300.

As can be appreciated from the above description, the image forming apparatus and user terminal device for providing guide information and the method of providing guide information thereof, according to exemplary embodiments of the present invention, analyze metadata of the image data to print in the image forming apparatus and user terminal device, and facilitate an improved printing option. Accordingly, an inexperienced user who is not knowledgeable with setting printing options and print image data can more easily obtain an improved image output.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus for providing guide information, comprising:
a controller for analyzing metadata of image data to print and generating guide information for a certain printing option based on the analyzed metadata;
a user interface for providing the generated guide information and receiving an input setting value for the printing option; and
a printing unit for printing the image data,
wherein the controller controls the printing unit to apply the input setting value for the printing option to the image data.

2. The image forming apparatus of claim 1, wherein the controller further comprises a guide information generator for analyzing the metadata of the image data and generating the guide information for the certain printing option based on the analyzed metadata.

3. The image forming apparatus of claim 1, wherein the printing option corresponds to a printing setting comprising a color mode, sharpness and brightness.

4. The image forming apparatus of claim 1, further comprising an image data input unit for reading the image data from an external storage medium,
wherein the controller receives the image data from the image data input unit.

5. The image forming apparatus of claim 4, wherein the external storage medium comprises at least one of a user terminal device, digital camera and digital camcorder.

6. The image forming apparatus of claim 1, wherein the user interface comprises:
a function key for inputting the setting value for the printing option; and
a display unit for displaying the guide information.

7. The image forming apparatus of claim 1, wherein the controller controls the printing unit to print a demonstration page of the guide information.

8. A user terminal device for providing guide information, comprising:
a guide information generator for analyzing metadata of image data to print and generating guide information for a certain printing option based on the analyzed metadata;
a driver comprising a driver user interface for providing the generated guide information to a user and receiving a setting value for the printing option from the user;
a driver controller for generating a printing control signal to apply the setting value for the printing option to the image data and print the image data; and
an image forming apparatus interface for transmitting the generated printing control signal to an image forming apparatus.

9. The user terminal device of claim 8, wherein the printing option corresponds to a printing setting comprising a color mode, sharpness and brightness.

10. The user terminal device of claim 8, further comprising a terminal device storage for storing the image data,
wherein the guide information generator receives the image data from the terminal device storage.

11. The user terminal device of claim 8, wherein the driver controller generates a printing control signal to print a demonstration page of the guide information.

12. A method of providing guide information, comprising:
analyzing metadata of image data to print;
generating guide information for a certain printing option based on the analyzed metadata;
applying the guide information to the image data; and
printing the image data.

13. The method of claim 12, wherein the printing option corresponds to a printing setting comprising a color mode, sharpness and brightness.

14. The method of claim 12, further comprising providing the guide information through at least one of a display device and a host device.

15. The method of claim 14, wherein the providing of the guide information comprises providing a demonstration page of the guide information by at least one of printing and displaying.

16. The method of claim 12, further comprising receiving a setting value for the printing option, if the setting value is set to print the image data different from the guide information.

17. The method of claim 12, further comprising storing the analyzed metadata, the generated guide information and the setting value for the printing option received in the metadata.

18. The method of claim 17, further comprising managing a history of the setting value for the printing option stored in the metadata.

19. The method of claim 17, further comprising printing the setting value for the printing option stored in the metadata.
